(19) United States
(12) Patent Application Publication
(10) Pub. No.: US 2014/0037135 A1
(43) Pub. Date: Feb. 6, 2014

(54) CONTEXT-DRIVEN ADJUSTMENT OF CAMERA PARAMETERS

(71) Applicants: Gershom Kutliroff, Alon Shvut (IL); Shahar Fleishman, Hod Hasharon (IL)

(72) Inventors: Gershom Kutliroff, Alon Shvut (IL); Shahar Fleishman, Hod Hasharon (IL)

(73) Assignee: Omek Interactive, Ltd., Bet Shemesh (IL)

(21) Appl. No.: 13/563,516

(22) Filed: Jul. 31, 2012

(51) Int. Cl. G06K 9/62; H04N 13/02

(52) U.S. Cl. 382/103; 348/46; 348/E13.074

(57) ABSTRACT

A system and method for adjusting the parameters of a camera based upon the elements in an imaged scene are described. The frame rate at which the camera captures images can be adjusted based upon whether the object of interest appears in the camera's field of view to improve the camera's power consumption. The exposure time can be set based on the distance of an object form the camera to improve the quality of the acquired camera data.

### BACKGROUND

Depth cameras acquire depth images of their environment at interactive, high frame rates. The depth images provide pixelwise measurements of the distance between objects within the field-of-view of the camera and the camera itself. Depth cameras are used to solve many problems in the general field of computer vision. In particular, the cameras are applied to HMI (Human-Machine Interface) problems, such as tracking people's movements and the movements of their hands and fingers. In addition, depth cameras are deployed as components for the surveillance industry, for example, to track people and monitor access to prohibited areas.

Indeed, significant advances have been made in recent years in the application of gesture control for user interaction with electronic devices. Gestures captured by depth cameras can be used, for example, to control a television, for home automation, or to enable user interfaces with tablets, personal computers, and mobile phones. As the core technologies used in these cameras continue to improve and their costs decline, gesture control will continue to play a major role in aiding human interactions with electronic devices.

### BRIEF DESCRIPTION OF THE DRAWINGS

Examples of a system for adjusting the parameters of a depth camera based on the content of the scene, are illustrated in the figures. The examples and figures are illustrative rather than limiting.

FIG. 1 is a schematic diagram illustrating control of a remote device through tracking of the hands/fingers, according to some embodiments.

FIG. 2 shows graphic illustrations of examples of hand gestures that may be tracked, according to some embodiments.

FIG. 3 is a schematic diagram illustrating example components of a system used to adjust a camera's parameters, according to some embodiments.

FIG. 4 is a schematic diagram illustrating example components of a system used to adjust the camera parameters, according to some embodiments.

FIG. 5 is a flow diagram illustrating an example process for depth camera object tracking, according to some embodiments.

FIG. 6 is a flow diagram illustrating an example process for adjusting the parameters of a camera, according to some embodiments.

### DETAILED DESCRIPTION

As with many technologies, the performance of depth cameras can be optimized by adjusting certain of the camera's parameters. Optimal performance based on these parameters varies, however, and depends on elements in an imaged scene. For example, because of the applicability of depth cameras to HMI applications, it is natural to use them as gesture control interfaces for mobile platforms, such as laptops, tablets, and smartphones. Due to the limited power supply of mobile platforms, system power consumption is a major concern. In these cases, there is a direct tradeoff between the quality of the depth data obtained by the depth cameras, and the power consumption of the cameras. Obtaining an optimal balance between the accuracy of the objects tracked based on the depth cameras' data, and the power consumed by these devices, requires careful tuning of the parameters of the camera.

The present disclosure describes a technique for setting the camera's parameters, based on the content of the imaged scene to improve the overall quality of the data and the performance of the system. In the case of power consumption in the example introduced above, if there is no object in the field-of-view of the camera, the frame rate of the camera can be drastically reduced, which, in turn, reduces the power consumption of the camera. When an object of interest appears in the camera's field-of-view, the full camera frame rate, required to accurately and robustly track the object, can be restored. In this way, the camera's parameters are adjusted, based on the scene content, to improve the overall system performance.

The present disclosure is particularly relevant to instances where the camera is used as a primary input capture device. The objective in these cases is to interpret the scene that the camera views, that is, to detect and identify (if possible) objects, to track such objects, to possibly apply models to the objects in order to more accurately understand their position and articulation, and to interpret movements of such objects, when relevant. At the core of the present disclosure, a tracking module that interprets the scene and uses algorithms to detect and track objects of interest can be integrated into the system and used to adjust the camera's parameters.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Description section.

A depth camera is a camera that captures depth images. Commonly, the depth camera captures a sequence of depth images, at multiple frames per second (the frame rate). Each depth image may contain per-pixel depth data, that is, each pixel in the acquired depth image has a value that represents the distance between an associated segment of an object in the imaged scene and the camera. Depth cameras are sometimes referred to as three-dimensional cameras.

A depth camera may contain a depth image sensor, an optical lens, and an illumination source, among other components. The depth image sensor may rely on one of several different sensor technologies. Among these sensor technologies are time-of-flight (TOF), (including scanning TOF or array TOF), structured light, laser speckle pattern technology, stereoscopic cameras, active stereoscopic sensors, and shape-from-shading technology. Most of these techniques rely on active sensor systems, that provide their own illumination sources. In contrast, passive sensor systems, such as stereoscopic cameras, do not supply their own illumination source, but depend instead on ambient environmental lighting. In addition to depth data, the depth cameras may also generate color data, similar to conventional color cameras, and the color data can be processed in conjunction with the depth data.

Time-of-flight sensors utilize the time-of-flight principle in order to compute depth images. According to the time-of-flight principle, the correlation of an incident optical signal, s, with a reference signal, g, that is the incident optical signal reflected from an object, is defined as:

$$C ( τ ) = s g = {lim}_{T \to ∞} {\int }_{- \frac{T}{2}}^{\frac{T}{2}} s ( t ) \cdot g ( t + τ ) d t$$

For example, if g is an ideal sinusoidal signal, fₘ is the modulation frequency, a is the amplitude of the incident optical signal, b is the correlation bias, and φ is the phase shift (corresponding to the object distance), the correlation is given by:

$$C ( τ ) = \frac{a}{2} cos ( {f}_{m} τ + ϕ ) + b$$

Using four sequential phase images with different offsets:

$$τ \text{:} {A}_{i} = C ( i \cdot \frac{π}{2} ) , i = 0 , … , 3.$$

the phase shift, the intensity and the amplitude of the signal can be determined by:

$$ϕ = arc tan 2 ( {A}_{2} = {A}_{1} , {A}_{0} - {A}_{2} )$$

$$I = \frac{{A}_{0} + {A}_{1} + {A}_{2} + {A}_{3}}{4}$$

$$a = \frac{\sqrt{{( {A}_{3} - {A}_{1} )}^{2} + {( {A}_{0} - {A}_{2} )}^{2}}}{2}$$

In practice, the input signal may be different from a sinusoidal signal. For example, the input may be a rectangular signal. Then, the corresponding phase shift, intensity, and amplitude would be different from the idealized equations presented above.

In the case of a structured light camera, a pattern of light (typically a grid pattern, or a striped pattern) may be projected onto a scene. The pattern is deformed by the objects present in the scene. The deformed pattern may be captured by the depth image sensor and depth images can be computed from this data.

Several parameters affect the quality of the depth data generated by the camera, such as the integration time, the frame rate, and the intensity of the illumination in active sensor systems. The integration time, also known as the exposure time, controls the amount of light that is incident on the sensor pixel array. In a TOF camera system, for example, if objects are close to the sensor pixel array, a long integration time may result in too much light passing through the shutter, and the array pixels can become over-saturated. On the other hand, if objects are far away from the sensor pixel array, insufficient returning light reflected from the object may yield pixel depth values with a high level of noise.

In the context of obtaining data about the environment, which can subsequently be processed by image processing (or other) algorithms, the data generated by depth cameras has several advantages over data generated by conventional, also known as “2D” (two-dimensional) or “RGB” (red, green, blue), cameras. The depth data greatly simplifies the problem of segmenting the background from the foreground, is generally robust to changes in lighting conditions, and can be used effectively to interpret occlusions. For example, using depth cameras, it is possible to identify and robustly track a user's hands and fingers in real-time. Knowledge of the position of a user's hands and fingers can, in turn, be used to enable a virtual “3D” touch screen, and a natural and intuitive user interface. The movements of the hands and fingers can power user interaction with various different systems, apparatuses, and/or electronic devices, including computers, tablets, mobile phones, handheld gaming consoles, and the dashboard controls of an automobile. Furthermore, the applications and interactions enabled by this interface may include productivity tools and games, as well as entertainment system controls (such as a media center), augmented reality, and many other forms of communication/interaction between humans and electronic devices.

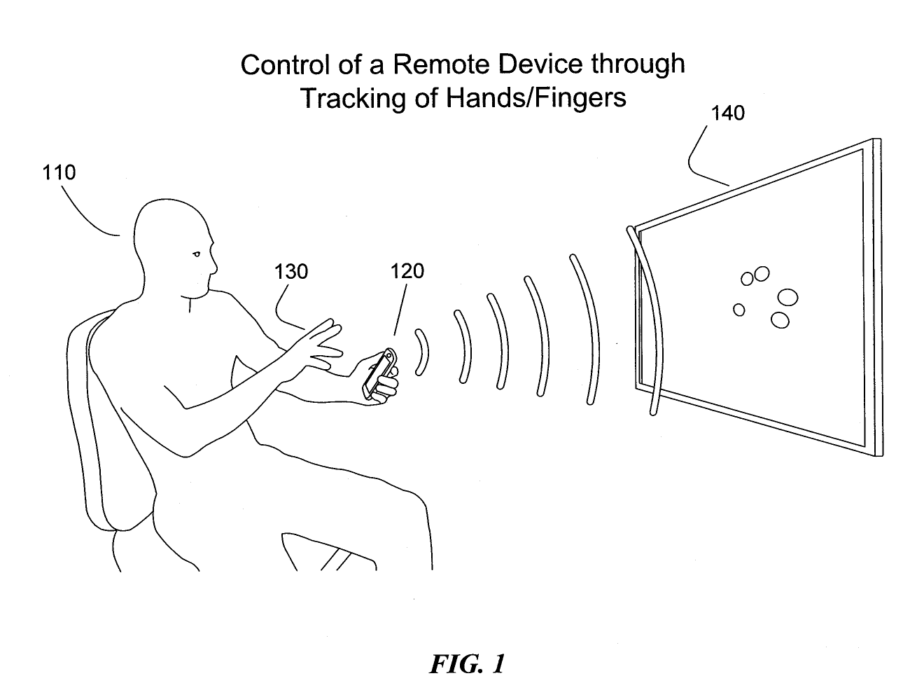

FIG. 1 displays an example application where a depth camera can be used. A user 110 controls a remote external device 140 by the movements of his hands and fingers 130. The user holds in one hand a device 120 containing a depth camera, and a tracking module identifies and tracks the movements of his fingers from depth images generated by the depth camera, processes the movements to translate them into commands for the external device 140, and transmits the commands to the external device 140.

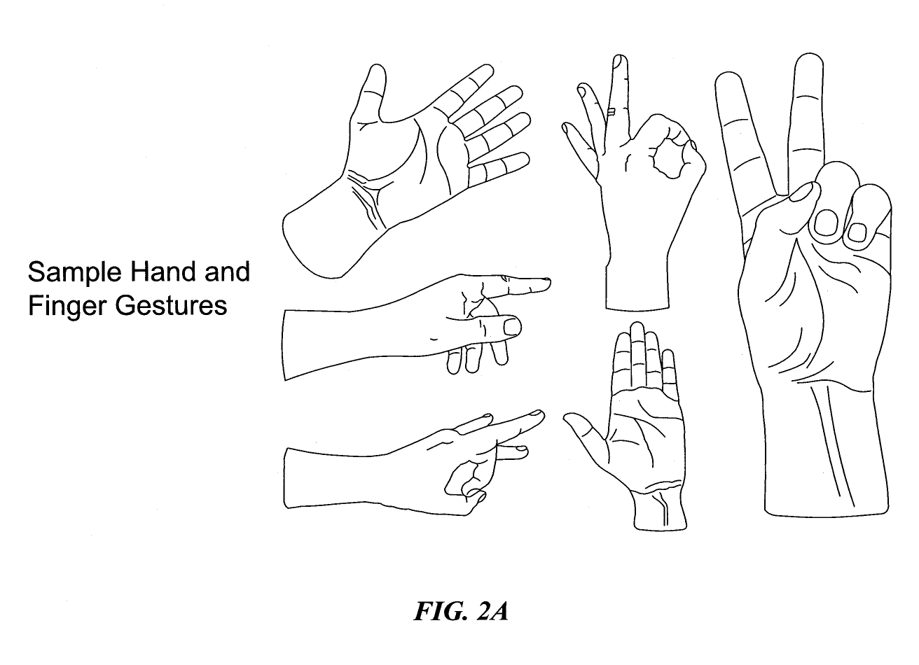

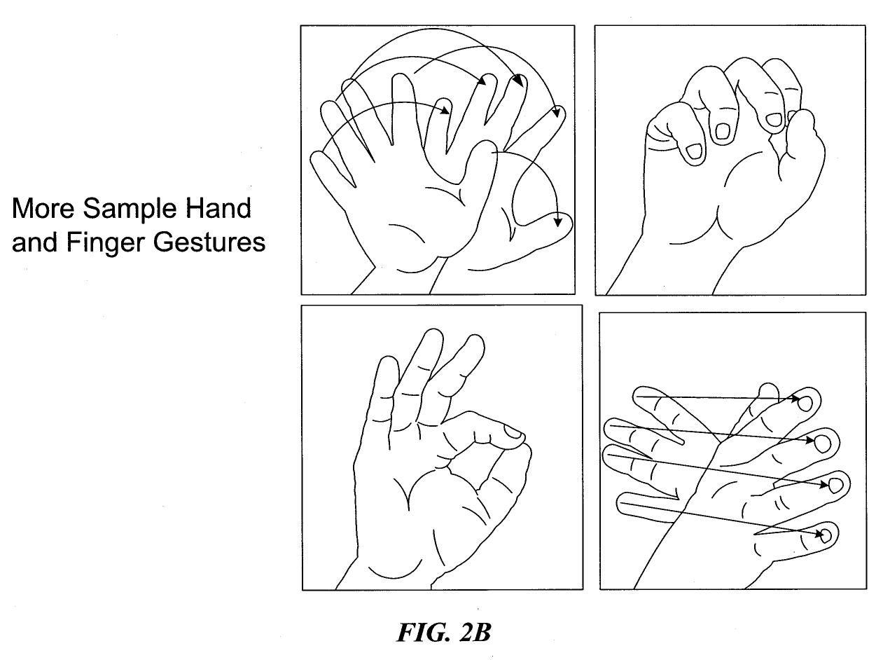

FIGS. 2A and 2B show a series of hand gestures, as examples of movements that may be detected, tracked, and recognized. Some of the examples shown in FIG. 2B include a series of superimposed arrows indicating the movements of the fingers, so as to produce a meaningful and recognizable signal or gesture. Of course, other gestures or signals may be detected and tracked, from other parts of a user's body or from other objects. In further examples, gestures or signals from multiple objects of user movements, for example, a movement of two or more fingers simultaneously, may be detected, tracked, recognized, and executed. Of course, tracking may be executed for other parts of the body, or for other objects, besides the hands and fingers.

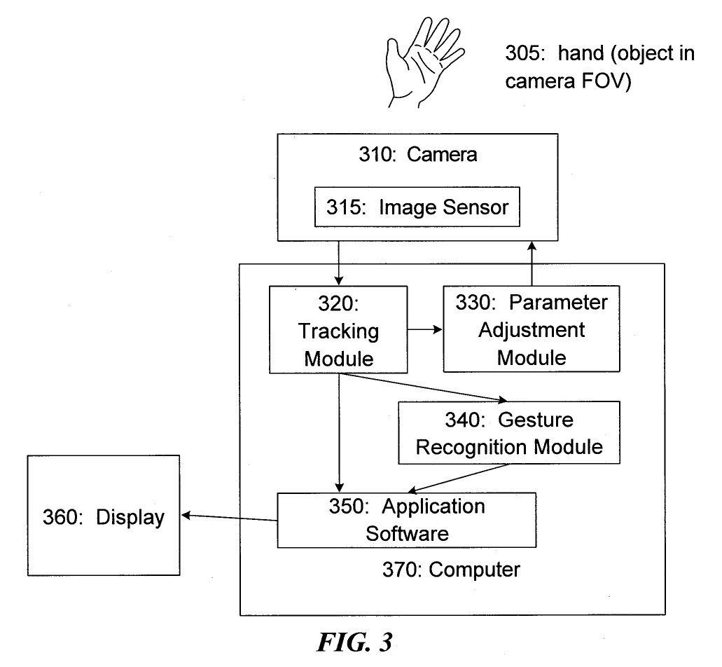

Reference is now made to FIG. 3, which is a schematic diagram illustrating example components for adjusting a depth camera's parameters to optimize performance. According to one embodiment, the camera 310 is an independent device, which is connected to a computer 370 via a USB port, or coupled to the computer through some other manner, either wired or wirelessly. The computer 370 may include a tracking module 320, a parameter adjustment module 330, a gesture recognition module 340, and application software 350. Without loss of generality, the computer can be, for example, a laptop, a tablet, or a smartphone.

The camera 310 may contain a depth image sensor 315, which is used to generate depth data of an object(s). The camera 310 monitors a scene in which there may appear objects 305. It may be desirable to track one or more of these objects. In one embodiment, it may be desirable to track a user's hands and fingers. The camera 310 captures a sequence of depth images which are transferred to the tracking module 320. U.S. patent application Ser. No. 12/817,102 entitled “METHOD AND SYSTEM FOR MODELING SUBJECTS FROM A DEPTH MAP”, filed Jun. 16, 2010, describes a method of tracking a human form using a depth camera that can be performed by the tracking module 320, and is hereby incorporated in its entirety.

The tracking module 320 processes the data acquired by the camera 310 to identify and track objects in the camera's field-of-view. Based on the results of this tracking, the parameters of the camera are adjusted, in order to maximize the quality of the data obtained on the tracked object. These parameters can include the integration time, the illumination power, the frame rate, and the effective range of the camera, among others.

Once an object of interest is detected by the tracking module 320, for example, by executing algorithms for capturing information about a particular object, the camera's integration time can be set according to the distance of the object from the camera. As the object gets closer to the camera, the integration time is decreased, to prevent over-saturation of the sensor, and as the object moves further away from the camera, the integration time is increased in order to obtain more accurate values for the pixels that correspond to the object of interest. In this way, the quality of the data corresponding to the object of interest is maximized, which in turn enables more accurate and robust tracking by the algorithms. The tracking results are then used to adjust the camera parameters again, in a feedback loop that is designed to maximize performance of the camera-based tracking system. The integration time can be adjusted on an ad-hoc basis.

Alternatively, for time-of-flight cameras, the amplitude values computed by the depth image sensor (as described above) can be used to maintain the integration time within a range that enables the depth camera to capture good quality data. The amplitude values effectively correspond to the total number of photons that return to the image sensor after they are reflected off of objects in the imaged scene. Consequently, objects closer to the camera correspond to higher amplitude values, and objects further away from the camera yield lower amplitude values. It is therefore effective to maintain the amplitude values corresponding to an object of interest within a fixed range, which is accomplished by adjusting the camera's parameters, in particular, the integration time and the illumination power.

The frame rate is the number of frames, or images, captured by the camera over a fixed time period. It is generally measured in terms of frames per second. Since higher frame rates result in more samples of the data, there is typically a proportional ratio between the frame rate and the quality of the tracking performed by the tracking algorithms. That is, as the frame rate rises, the quality of the tracking improves. Moreover, higher frame rates lower the latency of the system experienced by the user. On the other hand, higher frame rates also require higher power consumption, due to increased computation, and, in the case of active sensor systems, increased power required by the illumination source. In one embodiment, the frame rate is dynamically adjusted based on the amount of battery power remaining.

In another embodiment, the tracking module can be used to detect objects in the field-of-view of the camera. When there are no objects of interest present, the frame rate can be significantly decreased, in order to conserve power. For example, the frame rate can be decreased to 1 frame/second. With every frame capture (once each second), the tracking module can be used to determine if there is an object of interest in the camera's field-of-view. In this case, the frame rate can be increased so as to maximize the effectiveness of the tracking module. When the object leaves the field-of-view, the frame rate is once again decreased, in order to conserve power. This can be done on an ad-hoc basis.

In one embodiment, when there are multiple objects in the camera's field-of-view, a user can designate one of the objects to be used for determining the camera parameters. In the context of the ability of depth cameras to capture data used to track objects, the camera parameters can be adjusted so that the data corresponding to the object of interest is of optimal quality, improves the performance of the camera in this role. In a further enhancement of this case, a camera can be used for surveillance of a scene, where multiple people are visible. The system can be set to track one person in the scene, and the camera parameters can be automatically adjusted to yield optimal data results on the person of interest.

The effective range of the depth camera is the three-dimensional space in front of the camera for which valid pixel values are obtained. This range is determined by the particular values of the camera parameters. Consequently, the camera's range can also be adjusted, via the methods described in the present disclosure, in order to maximize the quality of the tracking data obtained on an object-of-interest. In particular, if an object is at the far (from the camera) end of the effective range, this range can be extended in order to continue tracking the object. The range can be extended, for example, by lengthening the integration time or emitting more illumination, either of which results in more light from the incident signal reaching the image sensor, thus improving the quality of the data. Alternatively or additionally, the range can be extended by adjusting the focal length.

The methods described herein can be combined with a conventional RGB camera, and the RGB camera's settings can be fixed according to the results of the tracking module. In particular, the focus of the RGB camera can be adapted automatically to the distance to the object of interest in the scene, so as to optimally adjust the depth-of-field of the RGB camera. This distance may be computed from the depth images captured by a depth sensor and utilizing tracking algorithms to detect and track the object of interest in the scene.

The tracking module 320 sends tracking information to the parameter adjustment module 330, and the parameter adjustment module 330 subsequently transmits the appropriate parameter adjustments to the camera 310, so as to maximize the quality of the data captured. In one embodiment, the output of the tracking module 320 may be transmitted to the gesture recognition module 340, which calculates whether a given gesture was performed, or not. The results of the tracking module 320 and the results of the gesture recognition module 340 are both transferred to the software application 350. With an interactive software application 350, certain gestures and tracking configurations can alter a rendered image on a display 360. The user interprets this chain-of-events as if his actions have directly influenced the results on the display 360.

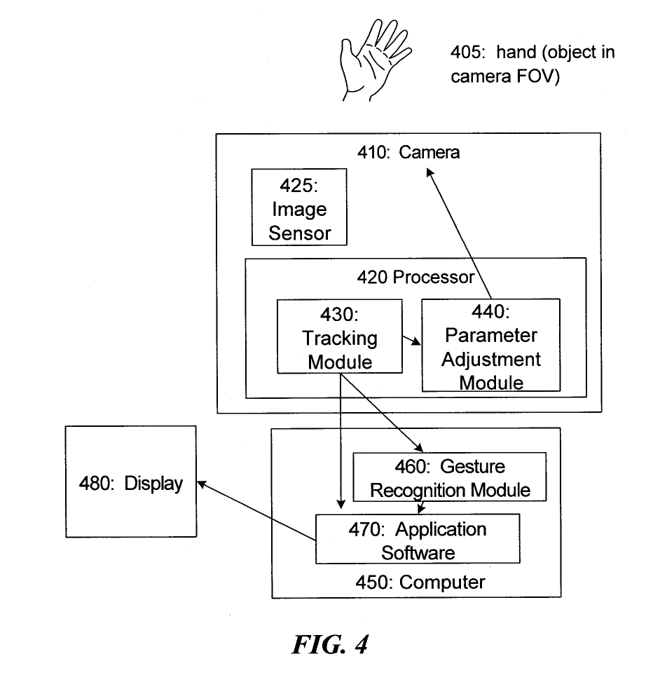

Reference is now made to FIG. 4, which is a schematic diagram illustrating example components used to set a camera's parameters. According to one embodiment, the camera 410 may contain a depth image sensor 425. The camera 410 also may contain an embedded processor 420 which is used to perform the functions of the tracking module 430 and the parameter adjustment module 440. The camera 410 may be connected to a computer 450 via a USB port, or coupled to the computer through some other manner, either wired or wirelessly. The computer may include a gesture recognition module 460 and software application 470.

Data from the camera 410 may be processed by the tracking module 430 using, for example, a method of tracking a human form using a depth camera as described in U.S. patent application Ser. No. 12/817,102 entitled “METHOD AND SYSTEM FOR MODELING SUBJECTS FROM A DEPTH MAP”. Objects of interest may be detected and tracked, and this information may be passed from the tracking module 430 to the parameter adjustment module 440. The parameter adjustment module 440 performs the calculations to determine how the camera parameters should be adjusted to yield optimal quality of the data corresponding to the object of interest. Subsequently, the parameter adjustment module 440 sends the parameter adjustments to the camera 410 which adjusts the parameters accordingly. These parameters may include the integration time, the illumination power, the frame rate, and the effective range of the camera, among others.

Data from the tracking module 430 may also be transmitted to the computer 450. Without loss of generality, the computer can be, for example, a laptop, a tablet, or a smartphone. The tracking results may be processed by the gesture recognition module 460 to detect if a specific gesture was performed by the user, for example, using a method of identifying gestures using a depth camera as described in U.S. patent application Ser. No. 12/707,340, entitled “METHOD AND SYSTEM FOR GESTURE RECOGNITION”, filed Feb. 17, 2010, or identifying gestures using a depth camera as described in U.S. patent application Ser. No. 7,970,176, entitled “METHOD AND SYSTEM FOR GESTURE CLASSIFICATION”, filed Oct. 2, 2007. Both patent applications are hereby incorporated in their entirety. The output of the gesture recognition module 460 and the output of the tracking module 430 may be passed to the application software 470. The application software 470 calculates the output that should be displayed to the user and displays it on the associated display 480. In an interactive application, certain gestures and tracking configurations typically alter a rendered image on the display 480. The user interprets this chain-of-events as if his actions have directly influenced the results on the display 480.

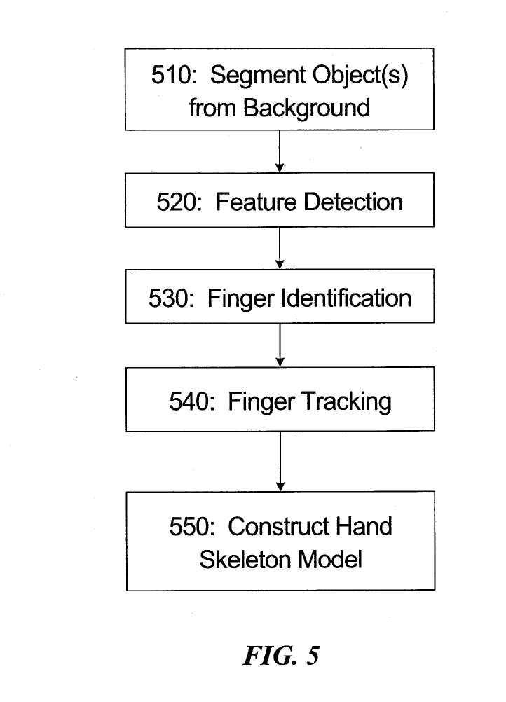

Reference is now made to FIG. 5, which describes an example process performed by tracking module 320 or 430 for tracking a user's hand(s) and finger(s), using data generated by depth camera 310 or 410, respectively. At block 510, an object is segmented and separated from the background. This can be done, for example, by thresholding the depth values, or by tracking the object's contour from previous frames and matching it to the contour from the current frame. In one embodiment, a user's hand is identified from the depth image data obtained from the depth camera 310 or 410, and the hand is segmented from the background. Unwanted noise and background data is removed from the depth image at this stage.

Subsequently, at block 520 features are detected in the depth image data and associated amplitude data and/or associated RGB images. These features may be, in one embodiment, the tips of the fingers, the points where the bases of the fingers meet the palm, and any other image data that is detectible. The features detected at block 520 are then used to identify the individual fingers in the image data at block 530. At block 540, the fingers are tracked in the current frame based on their locations in the previous frames. This step is important to help filter false-positive features that may have been detected at block 520.

At block 550 the three-dimensional points of the fingertips and some of the joints of the fingers may be used to construct a hand skeleton model. The model may be used to further improve the quality of the tracking and assign positions to joints which were not detected in the earlier steps, either because of occlusions, or missed features from parts of the hand that were outside of the camera's field-of-view. Moreover, a kinematic model may be applied as part of the skeleton at block 550, to add further information that improves the tracking results.

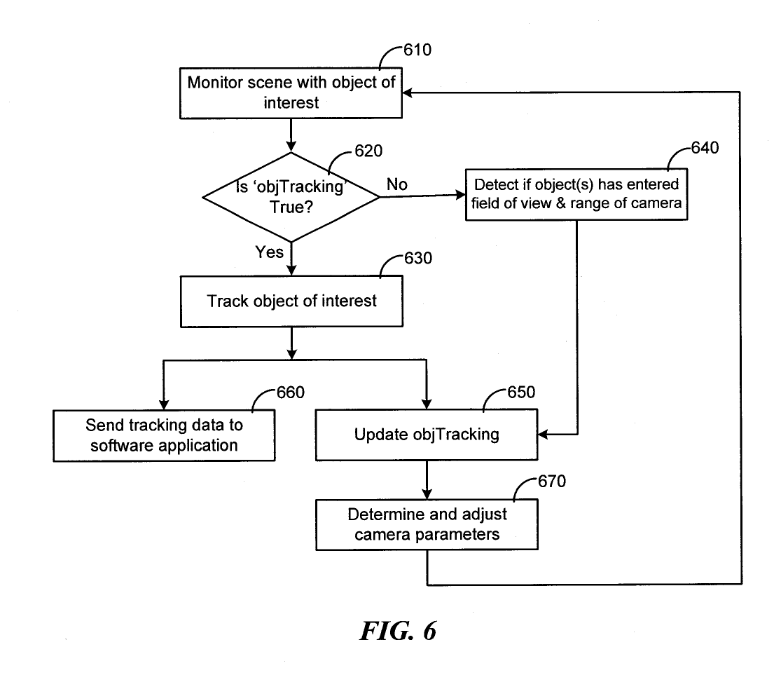

Reference is now made to FIG. 6, which is a flow diagram showing an example process for adjusting the parameters of a camera. At block 610, a depth camera monitors a scene that may contain one or multiple objects of interest.

A boolean state variable, “objTracking” may be used to indicate the state that the system is currently in, and, in particular, whether the object has been detected in the most recent frames of data captured by the camera at block 610. At decision block 620, the value of this state variable, “objTracking”, is evaluated. If it is “true”, that is, an object of interest is currently in the camera's field-of-view (block 620—Yes), at block 630 the tracking module tracks the data acquired by the camera to find the positions of the object-of-interest (described in more detail in FIG. 5). The process continues to blocks 660 and 650.

At block 660, the tracking data is passed to the software application. The software application can then display to the user the appropriate response.

At block 650, the objTracking state variable is updated. If the object-of-interest is within the field-of-view of the camera, the objTracking state variable is set to true. If it is not, the objTracking state variable is set to false.

Then at block 670, the camera parameters are adjusted according to the state variable objTracking and sent to the camera. For example, if objTracking is true, the frame rate parameter may be raised, to support higher accuracy by the tracking module at block 630. In addition, the integration time may be adjusted, according to the distance of the object-of-interest from the camera, to maximize the quality of the data obtained by the camera for the object-of-interest. The illumination power may also be adjusted, to balance between power consumption and the required quality of the data, given the distance of the object from the camera.

The adjustments of the camera parameters can be done on an ad-hoc basis, or through algorithms designed to calculate the optimal values of the camera parameters. For example, in the case of Time-of-Flight cameras (as described in the above description), the amplitude values represent the strength of the returning (incident) signal. This signal strength depends on several factors, including the distance of the object from the camera, the reflectivity of the material, and possible effects from ambient lighting. The camera parameters may be adjusted based on the strength of the amplitude signal. In particular, for a given object-of-interest, the amplitude values of the pixels corresponding to the object should be within a given range. If a function of these values falls below the acceptable range, the integration time can be lengthened, or the illumination power can be increased, so that the function of amplitude pixel values returns to the acceptable range. This function of amplitude pixel values may be the sum total, or the weighted average, or some other function dependent on the amplitude pixel values. Similarly, if the function of amplitude pixel values corresponding to the object of interest is above the acceptable range, the integration time can be decreased, or the illumination power can be reduced, in order to avoid over-saturation of the depth pixel values.

In one embodiment, the decision whether to update the objTracking state variable at block 650 can be applied once per multiple frames, or it may be applied every frame. Evaluating the objTracking state and deciding whether to adjust the camera parameters may incur some system overhead, and it would therefore be advantageous to perform this step only once for multiple frames. Once the camera parameters are computed, and the new parameters are transferred to the camera, the new parameter values are applied at block 610.

If the object of interest does not currently appear in the field-of-view of the camera 610 (block 620—No), at block 640 an initial detection module determines whether the object-of-interest now appears in the camera's field-of-view for the first time. The initial detection module could detect any object in the camera's field-of-view and range. This could either be a specific object-of-interest, such as a hand, or anything passing in front of the camera. In a further embodiment, the user can define particular objects to detect, and if there are multiple objects in the camera's field-of-view, the user can specify that a particular one or any one of the multiple objects should be used in order to adjust the camera's parameters.

Unless the context clearly requires otherwise, throughout the description and the claims, the words “comprise”, “comprising”, and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method comprising:
acquiring one or more depth images using a depth camera;
analyzing a content of the one or more depth images;
automatically adjusting one or more parameters of the depth camera based on the analysis.

2. The method of claim 1, wherein the one or more parameters includes a frame rate.

3. The method of claim 2, wherein the frame rate is further adjusted based on the depth camera's available power resources.

4. The method of claim 1, wherein the one or more parameters includes integration time, and the analysis includes a distance of an object of interest from the depth camera.

5. The method of claim 4, wherein the integration time is further adjusted to maintain a function of amplitude pixel values in the one or more depth images within a range.

6. The method of claim 1, wherein the one or more parameters includes a range of the depth camera.

7. The method of claim 1, further comprising adjusting a focus and depth of field of a red, green, blue (RGB) camera, wherein the RGB camera adjustments are based on at least some of the one or more parameters of the depth camera.

8. The method of claim 1, further comprising user input identifying an object to be used in the analysis for adjusting the one or more parameters of the depth camera.

9. The method of claim 8, wherein the one or more parameters includes a frame rate, wherein the frame rate is decreased when the object leaves a field of view of the camera.

10. The method of claim 1, wherein the depth camera uses an active sensor with an illumination source, and the one or more parameters includes a power level of the illumination source, and further wherein the power level is adjusted to maintain a function of amplitude pixel values in the one or more images within a range.

11. The method of claim 1, wherein analyzing the content comprises detecting an object and tracking the object in the one or more images.

12. The method of claim 11, further comprising rendering a display image on a display based on the detection and tracking of the object.

13. The method of claim 11, further comprising performing gesture recognition on the one or more tracked objects, wherein the rendering the display image is further based on recognized gestures of the one or more tracked objects.

14. A system comprising:
a depth camera configured to acquire a plurality of depth images;
a tracking module configured to detect and track an object in the plurality of depth images;
a parameter adjustment module configured to calculate adjustments for one or more depth camera parameters based on the detection and tracking of the object and send the adjustments to the depth camera.

15. The system of claim 14, further comprising a display and an application software module configured to render a display image on the display based on the detection and tracking of the object.

16. The system of claim 15, further comprising a gesture recognition module configured to determine whether a gesture was performed by the object, wherein the application software module is configured to render the display image further based on the determination of the gesture recognition module.

17. The system of claim 14, wherein the one or more depth camera parameters includes a frame rate.

18. The system of claim 17, wherein the frame rate is further adjusted based on the depth camera's available power resources.

19. The system of claim 14, wherein the one or more depth camera parameters includes an integration time adjusted based on a distance of the object from the depth camera.

20. The system of claim 19, wherein the integration time is further adjusted to maintain a function of amplitude pixel values in the one or more depth images within a range.

21. The system of claim 14, wherein the one or more depth camera parameters includes a range of the depth camera.

22. The system of claim 14, wherein the depth camera uses an active sensor with an illumination source, and the one or more parameters includes a power level of the illumination source, and further wherein the power level is adjusted to maintain a function of amplitude pixel values in the one or more images within a range.

23. A system comprising:
means for acquiring one or more depth images using a depth camera;
means for detecting an object and tracking the object in the one or more depth images;
means for adjusting one or more parameters of the depth camera based on the detection and tracking,
wherein the one or more parameters includes a frame rate, an integration time, and a range of the depth camera.
